(19) United States
(12) Patent Application Publication
(10) Pub. No.: US 2006/0174029 A1
(43) Pub. Date: Aug. 3, 2006

(54) Method and device for exchanging data by means of tunnel connection

(75) Inventors: Thuy-Phuong Le, Schwerte (DE); Werner Linderman, Mulheim (DE); Norbert Schonfeld, Dortmund (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft, Muenchen (DE)

(21) Appl. No.: 10/533,083

(22) PCT Filed: Sep. 12, 2003
(86) PCT No.: PCT/DE03/03029

§ 371 Date: Apr. 28, 2005

(30) Foreign Application Priority Data
Oct. 28, 2002 (DE) 102 50 201.3

(51) Int. Cl. G06F 15/16

(52) U.S. Cl. 709/236

(57) ABSTRACT

The aim of the invention is to exchange data between an external device and applications installed on network elements of a packet-switching network by means of at least one tunnel connection. Said aim is achieved by connecting each network element to a network node device that is part of the tunnel connection while a global address is unambiguously assigned to the terminal point of the tunneled connection, which is located at the network end. The network node device forms the terminal point of the tunnel connection, which is located at the network end, if several network elements jointly utilize said tunnel connection, one of the network elements establishing a tunnel connection and forming the terminal point at the network end thereof if said network element requires a global address for executing an application, a time during which said tunnel connection is used exclusively by said one network element while all data is routed through the network node device.

### CROSS REFERENCE TO RELATED APPLICATIONS

This application is the US National Stage of International Application No. PCT/DE2003/003029, filed Sep. 12, 2003 and claims the benefit thereof. The International Application claims the benefits of German application No. 10250201.3 filed Oct. 28, 2002, both applications are incorporated by reference herein in their entirety.

### FIELD OF THE INVENTION

The invention relates to a method an apparatus for interchanging data using a tunnel connection.

### SUMMARY OF THE INVENTION

Modern networks for interchanging data frequently operate in packet-switched mode, i.e. the information to be transmitted is bundled to form packets, is provided with the network address of the receiver and is then transported to the receiver in the network using this address. In this context, the structure of such a data packet and the type of addressing are stipulated in a communication protocol to which all entities in the network must adhere. Such a communication protocol is the Internet protocol (IP protocol), for example, which is also used in the largest data network in the world, the Internet. The Internet protocol is also called a connectionless communication protocol, because each network element connected to such a communication network, for example a PC, can send data packets to other network elements and can receive data packets from these other network elements without setting up a direct communication connection beforehand. A prerequisite for successful data interchange in this case is firstly that each network element be provided with an address, that is to say the Internet address (IP address), and secondly that this IP address be allocated in the communication network under consideration uniquely, that is to say not a plurality of times.

Besides the Internet, which can also be regarded as a public communication network, there are other networks, frequently with local limits, of different magnitudes. Such—usually private—networks are also called LANs (Local Area Networks). By way of example, these may be miniature networks belonging to private customers, comprising two or three network elements, or else company networks comprising several thousand network elements. In this case, the network elements of the local area networks, just like the network elements of the Internet, have associated unique addresses, and although each of these addresses is unique in the local area network it does not have a unique reference to the public communication network, that is to say the Internet.

Local area networks are frequently connected at least temporarily to the Internet. This is done, by way of example, in order to access websites on the Internet, to send and receive e-mails or else for the purposes of real-time communication in the form of voice-over-IP telephone calls or video conferences. To connect a local area network to the Internet, normally the services of an Internet service provider (ISP) are used. To this end, a data connection between the local area network and the network node of the service provider is set up at least temporarily. Thus, while the communication protocol used within a packet-switching network is a connectionless communication protocol, the connection between a local area network and a service provider may be connection-oriented, which firstly is on account of the need for charging for the connection (billing) and secondly allows better control of the data transmitted to and from the service provider.

For the connection between the local area network and the Internet service provider, different technical access variants and communication protocols are known which are selected according to the technical and local circumstances. Besides access using a modem and an analog telephone line, a digital ISDN connection or directly via an Ethernet data line, the use of asynchronous digital data lines (ADSL, DSL) is widespread today. In this case, the operator of the local area network is provided with a modem which has a network connection to the local area network and uses a data line for the connection to the service provider.

To interchange data between the local area network and the modem (DSL modem), this modem is first used to set up a tunnel connection based on the PPTP protocol (Point to Point Tunneling Protocol). Using this tunnel connection, the network element of the local area network, which is connected to the modem, obtains a globally unique Internet address from the address range of the Internet. Using this Internet address, this network element can be addressed from the Internet and can communicate with a remote station from the Internet using a data stream “tunneled” via the tunnel connection. This address allocation continues to be valid for the duration of the connection which is transmitted via the tunnel connection. A distinction is thus drawn between the tunnel connection as “transport medium” and the tunneled connection as “logical data channel”. The tunneled connection, to which the global address applies, is a “PPP session” or “PPP connection” (PPP=Point-to-Point Protocol) which is transmitted within the tunnel. However, the tunnel connection may continue to exist and may be used for further PPP connections even after the PPP connection has been cleared down. A PPTP tunnel connection can also be used to route a plurality of tunneled (PPP) connections at the same time.

The reason for the merely “loaned” allocation of a globally unique Internet address is the very limited stock of free, that is to say as yet unused, globally unique Internet addresses.

Thus, while the network element is communicating with the other network elements of the local area network using the local IP addresses, the temporarily—also called dynamically—allocated globally valid and globally unique Internet address is used for data interchange with the Internet via the tunnel connection and via the service provider. Local addresses are in turn used for the tunnel itself.

If just a single network element is connected to the modem, then this network element receives a globally unique Internet address allocated from the address space of the Internet for the duration of the tunneled PPP connection and thus becomes part of the Internet for the duration of the tunneled connection. If a plurality of network elements of a local area network are intended to use the modem to interchange data with the Internet at the same time, however, each of these network elements requires the allocation of its own globally unique IP address which is thus different than the other network addresses on the Internet. However, this is possible only when the tunnel is not set up between a PC as network element of the local area network and the modem, but rather when the tunnel connection is set up between a central network node device in the local area network and the modem. Such a network node device is frequently also called a router in the literature. Hence, the globally unique IP address provided by the Internet service provider for the duration of the PPP connection is allocated only to the router (to be precise, as explained further below, to an entity within the router). The data traffic within the local area network between the network elements of the network and the router thus continues to be effected using the only locally unique IP addresses, whereas the data traffic between the router and the Internet service provider and hence the Internet is effected with addressing using the globally unique IP address.

Since data packets which are transmitted in line with the Internet protocol have to be identified both with the Internet address of the receiver and with the IP address of the sending network element, the router comprises an entity which performs appropriate address translation for the data traffic between the network elements of the local area network and those of the Internet. One known method for such translation is the NAT (Network Address Translation) method. In this case, data packets which are sent from a network element in the local area network to a receiver in the Internet are first sent from the locally arranged network element to the router. The receiver address used for the data packets in this case is in fact the globally unique address of the receiver, while only the locally unique IP address of the network element may be used as “sender address”. The data packet is received by the NAT entity of the router, which then replaces the merely locally unique “sender address” with the globally unique Internet address which was temporarily allocated when the PPP connection was set up. The data packet now no longer has any formal distinction from other data packets which are interchanged between network elements of the Internet itself, and can thus be transmitted from the router via the PPP connection to the Internet service provider and hence to any desired network element of the Internet.

In this case, the router's NAT entity stores important data about the translation process, particularly the IP port number of the sending application. If a further data packet is now sent, for example in response to the data packet which is sent to a network element of the Internet, from the Internet to the router via the modem's tunnel connection this time, then this data packet is identified (in terms of its “receiver address”) by the temporarily valid and globally unique IP address allocated to the router. A further receiver feature of the data packet is the IP port number of that application which is ultimately intended to receive the data packet. The router processes this data packet using the NAT entity and ascertains the local network address of the network element with the correct application from the previously stored data, namely from the IP port number. In the data packet, the globally valid “receiver address” is now replaced with the local IP address of the network element, and then the data packet is forwarded to this network element in the local area network.

The NAT method thus allows the use of a single PPP connection to an Internet service provider by a plurality of network elements in a local area network at the same time without the need for a dedicated globally unique Internet address to be obtained from the Internet service provider for each of these network elements.

The method described reaches its limits when applications are used for data interchange which do not just use a globally unique IP address for addressing the full data packets, but also take the globally unique Internet address as a reference within the user data transported in the data packets. In respect of the ISO/OSI layer model, it is said that the IP addresses are used in “higher protocol layers”.

Two known applications which operate in this manner are the programs “Microsoft Net Meeting” and “active ftp”, for example. For these and some other applications, it is important that the network element on which they are installed and run has an associated globally unique Internet address. If such applications are used in a local area network which uses the NAT function described to interchange data with the Internet, the router's NAT entity does not just need to translate the addressing of the data packets sent and received, but also needs to analyze the content of the data packets themselves and needs to adjust the addressing in the higher protocol layers when the data packets come from one of the applications described. However, this has the drawback that the NAT entity needs to be designed to analyze the entire data traffic and also needs to be set up for the specific transmission protocols of all possible applications.

A further drawback is that in the case of data packets which arrive at the NAT entity from the Internet and are not a response to a data packet which has already been sent by a network element of the local area network previously, the NAT entity does not contain any stored information about the “correct” receiver from the local area network.

This drawback is partially overcome by virtue of a destination network element being predefined for a series of known IP port numbers for incoming data packets which cannot be allocated using stored information. In this context, reference is also made to “exposed machines”. Here, use is made of the fact that a series of IP port numbers (also referred to as well-known ports) each have a particular associated application type and can thus be sent from the NAT entity to a (or the) network element with the appropriate application. This form of routing is limited to a single application for each IP port number and thus to a single network element of the local area network, however.

The document, WO 01/71977 A2 Bosco et al. “Home Networking” shows an arrangement in which a plurality of network elements (“client device”) are connected to an external device (“host system”) via a network node device (“home gateway device”). In this arrangement, the network node device comprises an address conversion device (NAT entity), which converts the local addresses of the network elements into a global address for the external device, and vice versa. For applications in which one of the network elements is intended to be allocated a global address by the external device, the network node device sets up a tunnel connection which is representative of the network element in question to the external device upon request by the application, the application in question being assigned the network's global IP address of the tunnel connection, and the tunneled data intended for the application being transmitted to the application by the network node device.

In many cases, the safest and in practice only feasible way of using particular applications is for the appropriate network element of such an application to be connected to the modem directly, that is to say with the exclusion of the router. In that case, the PPTP tunnel setup is no longer effected between a logical entity of the router and the modem, but rather between the affected network element itself and the modem. The PPP connection is thus set up directly between the network element and the Internet service provider. The advantage that the network element itself is thus allocated the globally unique Internet address and hence also that the applications described can be operated with the particular requirements is opposed by the drawback that the network connection of the network element needs to be connected directly to the modem. This normally requires that the connector be plugged into another socket manually. In this case, the network element is no longer connected to the other network elements while this connection is being used.

It is an object of the invention to simplify the operation of a PC with installed applications as a network element in a packet-switching network.

This object is achieved by the claims.

In accordance with the solution, if one of the network elements requires a global address for executing an application it sets up a tunnel connection and forms the latter's network-end terminal point, this tunnel connection being used only by this network element, and all tunneled data being routed through the network node device. This means that it is also possible to use applications which require the globally valid IP address to be associated with the network element itself.

The characterizing features of the dependent claims advantageously refine the invention further.

If the network node device may alternately or simultaneously be a terminal point or a data-routing entity of a tunnel connection and/or of a plurality of tunnel connections, it is possible for a plurality of network elements to use the NAT method, while those network elements running applications with particular requirements may still be the terminal point of a tunnel connection. It is then not necessary to recable the arrangement.

It is possible to communicate with external devices in a tried-and-tested manner if the tunnel connection is a connection which operates on the basis of the PPTP tunneling protocol and which transmits the data in a tunneled connection without influence.

If the network elements are PCs and the external device is an Internet service provider connected by means of a DSL modem, it is possible for the network elements to interchange data with stations on the Internet.

The number of globally unique IP addresses required is reduced when the network elements have associated local addresses which are unique only in the packet-switching network.

If the network node device is a router which has an entity for setting up and operating a PPTP tunnel connection, the network-internal data traffic can be handled with the same appliance as also allows access to external devices.

### BRIEF DESCRIPTION OF THE DRAWINGS

An exemplary embodiment of the invention is explained in more detail below with reference to the drawings, in which:

FIG. 1 shows a router as a network node device with a connected PC as a network element, access to the ISDN and access to an Internet service provider as an external device,

FIG. 2 shows the data transmission between a network element and an Internet service provider when the NAT method is used,

FIG. 3 shows a tunneled connection which connects the router to the Internet service provider via a modem, and

FIG. 4 shows a tunneled connection which is connected between the network element and the Internet service provider via the router.

### DETAILED DESCRIPTION OF THE INVENTION

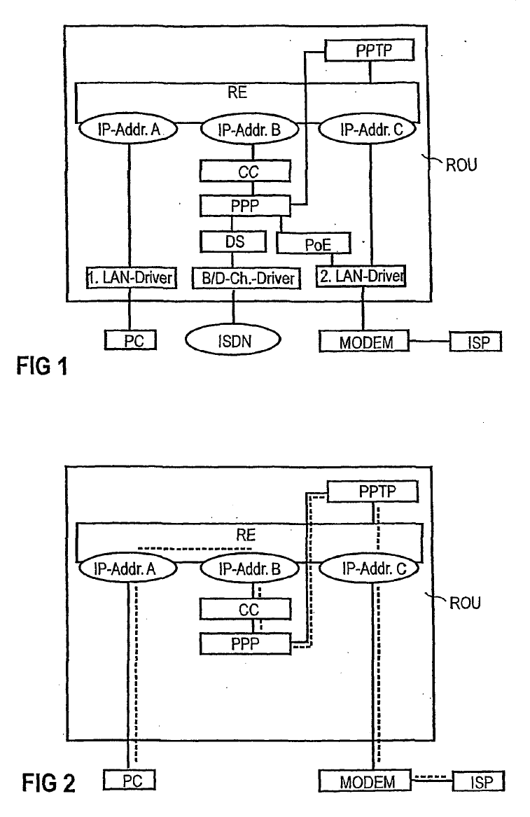

FIG. 1 shows a router ROU of the network node device to which the network elements of a local area packet-switching network LAN are connected. From these network elements, the network element PC in the form of a computer is considered by way of example.

The router ROU has access to the public communication network ISDN and is connected to a modem MODEM (“DSL modem”) which is connected via a DSL connection to the network node of an Internet service provider ISP, Internet provider for short.

The router ROU is internally provided with a routing unit RE which switches data packets inside the appliance using IP addresses. In this case, internal switching destinations for the routing unit RE are internal interfaces identified by IP-Addr.A (IP address A), IP-Addr.B (IP address B) and IP-Addr.C (IP address C). The router ROU is equipped, on the interfaces to the network elements and transmission lines which are connected to it, with respective line drivers which ensure the electrical and logical adjustment to suit the appropriate line medium. These line drivers are denoted by 1.LAN-Driver, B/D-Ch.-Driver and 2.LAN-Driver in FIG. 1; to improve clarity, the rest of the figures no longer contain these line drivers.

The router ROU comprises an ISDN protocol unit DS (“Digital Subscriber Stack”) and the aforementioned ISDN line driver B/D-Ch.-Driver for access to the public communication network ISDN. These entities and devices are not shown in more detail in the subsequent FIGS. 2, 3 and 4 because in this exemplary embodiment the data transmission described is effected merely via the DSL modem MODEM. The same applies to the “Point-to-Point over Ethernet” unit PoE, which connects the router to the DSL modem in a connection type which is not considered in more detail below.

The network element PC can, in principle, interchange data with the Internet service provider ISP in two different ways.

FIG. 2 shows the data transmission between the network element PC and the Internet service provider ISP when using the NAT method. In this case, the NAT method is implemented in the software of the router ROU; an “NAT entity” is also referred to in this context. The network element PC uses merely locally unique IP addresses to interchange the data packets with the router ROU, the data packets being translated in the router ROU in line with the known NAT (Network Address Translation) method. The path taken by the data packets in this case between the network element PC and the Internet service provider ISP is shown as a broken dashed line in FIG. 2. To be able to route the data packets which are sent by the network element PC and are provided with the local IP address of the network element PC as “sender address” to the Internet service provider ISP, the NAT entity needs access to a PPP connection which has been set up to the Internet service provider ISP.

Setup and cleardown of this PPP connection are controlled by a connection control device CC (“Connection Control”). This control device CC sets up such a connection upon request, then monitors whether this connection is used further, and ensures that the PPP connection is cleared down again in pauses in use.

The interface identified by IP-Addr.A is preset in the network element PC as standard address for those data packets which need to be sent to addresses on the Internet. It is also said that the IP address of the interface IP-Addr.A is configured as the “default gateway” in the network element PC. The network element PC now sends a first data packet to an IP address on the Internet. The routing unit RE forwards this data packet (and all subsequent data packets) to the interface identified by IP-Addr.B, from where the data packet is sent to the connection control CC.

At this instant, there is still no connection to the Internet service provider ISP, which means that the connection control CC prompts setup of such a connection. To this end, the protocol unit (entity) PPP (“Point-to-Point Protocol”) starts point-to-point connection setup to the Internet service provider ISP. The protocol unit PPP stores the keyword and the password for the access account of the operator of the local area network with the Internet service provider ISP.

In this case, the protocol unit PPP is preset such that it prompts setup of a tunnel connection using the modem MODEM if said tunnel connection has not already been set up. To this end, a tunnel protocol unit (entity) PPTP (“Point-to-Point Tunneling Protocol”) is turned on which ultimately prompts the tunnel connection (PPTP tunnel) between the routing unit RE, namely on the interface IP-Addr.C, and the modem MODEM.

When the tunneled connection has been set up, the Internet service provider ISP sends the router ROU or its PPP entity a globally unique IP address which is valid for the duration of this PPP connection and which is logically combined by the routing unit RE with the interface identified as IP-Addr.B. The NAT entity of the router ROU now uses this globally unique IP address which has been obtained to replace it with the merely locally unique and valid IP address of the network element PC in the data packets which are to be transmitted and thus to use the tunnel connection with this network element PC and with further network elements (not shown here).

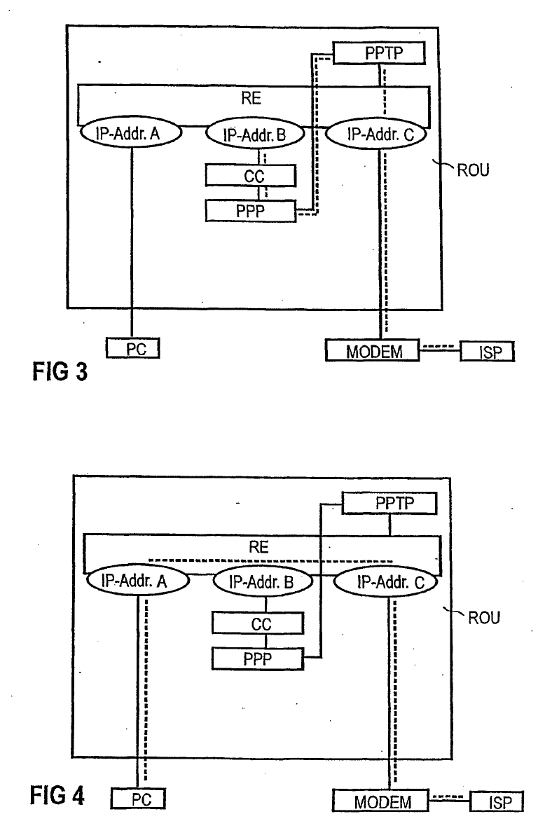

FIG. 3 schematically shows the tunneled connection, which connects the router ROU to the Internet service provider ISP via the modem MODEM, by means of a broken dashed line. The tunnel connection used by the tunneled connection starts at the PPTP entity PPTP and ends at the modem MODEM.

The first data packet and all further, subsequent data packets and response data packets are now transmitted between the network element PC and the Internet service provider ISP using the tunnel connection. In this case, the response data packets are encapsulated, that is to say addressed using “tunneling information”, by the modem MODEM, are sent to the interface IP-Addr.C of the router ROU and from there are forwarded to the PPTP entity. There, the “tunneling information” is removed—also referred to as “unpacking”—and the data packets are routed to the network element PC via the PPP entity and the interfaces IP-Addr.B, IP-Addr.A.

The connection control device CC prompts cleardown of the PPP connection when it is not being used any more for a prescribed length of time. The PPTP tunnel can then either likewise be cleared down or can be kept open until it is next used by a new PPP connection. If there is yet another PPP connection at the same time, the PPTP tunnel naturally cannot be cleared down.

Besides the NAT entity, the router ROU contains a filter device (not shown) which is active, which is often also called a “firewall” and which prevents unauthorized access to network elements.

The access (outlined above) using the NAT method cannot be used in every instance of application.

In this regard, the text below considers the case in which an application on the network element PC is started which works only if the network element PC itself has an associated globally unique IP address. To this end, a PPP connection is now set up between the network element PC itself and the Internet service provider ISP, which is shown schematically in FIG. 4. There is normally just one PPTP tunnel for a modem MODEM, but a plurality of parallel PPP connections which are routed through it. In principle, the arrangement shown allows parallel operation of the method already described with the inclusion of the NAT protocol and a direct tunnel connection between one of the network elements PC and the modem MODEM. For this, the Internet service provider ISP and the modem MODEM need to have the necessary technical prerequisites; in particular, a further globally unique IP address needs to be provided which is not needed for the PPTP tunnel, but rather for the PPP connection. Otherwise, as in the present case, an already existing tunnel connection between the router ROU and the modem MODEM needs to be cleared down before a direct tunnel connection is set up between a network element PC and the modem MODEM.

To be able to set up a PPP connection between the network element PC and the Internet service provider ISP, the protocol units PPP and PPTP known from the router ROU must already be available in the network element PC, which is done by loading an appropriate piece of software.

To operate a tunnel connection, the two entities at the tunnel ends each have a permanently associated IP address. These two IP addresses do not need to be (and are usually also not) globally unique, but rather are unique only for the local area network. Hence, while the first of these two IP addresses is associated with the modem's end of the tunnel connection, the second IP address in this pair of addresses is associated with the network's end of the tunnel connection. In the case of the access (described above) using the NAT method, the network's tunnel end is arranged on the interface IP-Addr.C and is thus a routing destination for the internal routing unit RE. In the case which is currently under consideration, the tunnel connection is routed from the network element PC via the router ROU to the modem, however, which means that to set up this tunnel connection the network adapter (network card) of the network element PC is allocated a second IP address in the pair of addresses, which belongs to the local address range. This is done using a unique administration process; the IP addresses in the pair of addresses are permanently allocated after that. To set up the tunneled connection, the PPP protocol unit of the network element PC addresses the PPTP protocol unit of the same network element PC, which in turn sends a first start data packet, addressed using the first IP address in the pair of addresses, to the network node unit ROU in order to set up the connection.

The internal routing unit RE is preset such that this data packet (and all subsequent data packets addressed in this way) is forwarded to the line termination to which the modem MODEM is connected. The start data packet is thus sent to the modem MODEM, where this start data packet receives a response. The response data packet is addressed using the second IP address from the pair of addresses and is sent to the internal routing unit RE by the modem MODEM. The routing unit RE is preset such that all data packets, and hence also the response data packet, which the modem MODEM sends to the interface identified by IP-Addr.C in the routing unit RE are routed to the internal interface IP-Addr.A. Such processes are also called “host routing” and “proxy ARP”. The NAT entity of the router ROU does not carry anything in this case. Finally, the response data packet is transported to the interface IP-Addr.A and thus to the network element PC with the second IP address of the tunnel connection.

The tunnel connection ends at this point, which means that the encapsulation, which essentially comprises the identification with the address pair, is removed by the PPTP protocol unit arranged at this point. The resultant data packet and further data packets are first of all used for ultimate setup of the point-to-point connection by the PPP protocol unit. During this point-to-point connection setup, the network element PC is allocated a globally unique IP address which is valid for the duration of this session. The tunnel connection which is set up as a result is frequently referred to as a “data communication connection” in the case of network elements which use the known operating system “MS Windows”.

The network element PC is programmed or user-controlled such that depending on the application which is active on the network element PC either an “indirect” tunnel connection (the router sets up the tunnel connection and the NAT method is used) or else a “direct” tunnel connection (the network element itself sets up the tunnel connection) is set up, with both modes of operation being able to be implemented alternately or simultaneously, depending on the technical circumstances of the modem and of the Internet service provider ISP.

1.-7. (canceled)

8. A method for interchanging data between an external device and applications installed on a plurality of network elements of a packet-switching network using a tunnel connection, wherein each network element is connected to a network node device, and wherein the network node device is involved in the tunnel connection, the method comprising:
assigning to a network-end terminal point of the tunnel connection a globally unique address, wherein the network node device forms the network-end terminal point of the tunnel connection if a plurality of network elements jointly use the tunnel connection; and
setting up the tunnel connection and forming the network-end terminal point of the tunnel connection by a network element if the network element requires a global address for executing an application, wherein the tunnel connection is exclusively used by the network element, wherein
all data are routed through the network node device, and wherein
the network node device is a terminal point or a data-routing entity of the tunnel connection.

9. The method as claimed in claim 8, wherein the tunnel connection is a connection which operates on the basis of the PPTP tunneling protocol and which transmits the data in a tunneled connection without influence.

10. The method as claimed in claim 8, wherein the network elements are computers and the external device is an Internet service provider connected by a DSL modem.

11. The method as claimed in claim 10, wherein the computers are Personal Computers.

12. The method as claimed in claim 9, wherein the network elements are computers and the external device is an Internet service provider connected by a DSL modem.

13. The method as claimed in claim 8, wherein the network elements have associated local addresses which are unique only in the packet-switching network.

14. The method as claimed in claim 9, wherein the network elements have associated local addresses which are unique only in the packet-switching network.

15. The method as claimed in claim 10, wherein the network elements have associated local addresses which are unique only in the packet-switching network.

16. The method as claimed in claim 8, wherein the network node device is a router which has an entity for setting up and operating a PPTP tunnel connection.

17. The method as claimed in claim 9, wherein the network node device is a router which has an entity for setting up and operating a PPTP tunnel connection.

18. The method as claimed in claim 10, wherein the network node device is a router which has an entity for setting up and operating a PPTP tunnel connection.

19. The method as claimed in claim 13, wherein the network node device is a router which has an entity for setting up and operating a PPTP tunnel connection.

20. The method as claimed in claim 8, wherein the network node device is alternately a terminal point or a data-routing entity of the tunnel connection.

21. The method as claimed in claim 8, wherein the network node device is simultaneously a terminal point and a data-routing entity of the tunnel connection.

22. The method as claimed in claim 8, wherein the network node device is a terminal point or a data-routing entity of a plurality of tunnel connections.

23. A network node device involved in interchanging data using at least one tunnel connection between an external device and applications installed on a plurality of network elements of a packet-switching network, wherein
each network element is connected to a network node device, wherein
a network-end terminal point of the tunnel connection has a uniquely allocated global address, wherein
the network node device forms the network-end terminal point of the tunnel connection if a plurality of network elements jointly use the tunnel connection, wherein,
if a network element requires a global address for executing an application, the network element sets up the tunnel connection and forms the network-end terminal point of the tunnel connection, wherein
the tunnel connection is configured to be exclusively used by the network element, and all data are routed through the network node device.
